(19) United States
(12) Patent Application Publication
(10) Pub. No.: US 2016/0097521 A1
(43) Pub. Date: Apr. 7, 2016

(54) Firefighter's Emergency Boot Light

(71) Applicants: Christopher J. Sullivan, Saint John, IN (US); Pamela R. Eanes, Munster, IN (US)

(72) Inventors: Christopher J. Sullivan, Saint John, IN (US); Pamela R. Eanes, Munster, IN (US)

(21) Appl. No.: 14/503,445

(22) Filed: Oct. 1, 2014

(51) Int. Cl. F21V 23/04; A62B 17/00; F21V 31/00; A43B 3/00; F21V 33/00; F21L 4/08

(52) U.S. Cl. CPC F21V 23/0407; F21V 33/0008; F21V 33/0076; F21L 4/08; F21V 31/005; A43B 3/001; A62B 17/003; F21W 2111/10

(57) ABSTRACT

A firefighter's emergency boot light that has a built-in LED light generator position to cast a beam of light out of the bottom of a heel or sole of a fireman's boot. The light source can cast a very bright, blinking beam of light out of the bottom of the boot in a backwards direction to allow a firefighter crawling behind another to see the feet one crawling ahead inside a dark, smoky structure. The LEDs typically are white for maximum visibility, and typically blink at a rate of several times a second. The LEDs are electronically activated either from a radio unit located at a control point for example, on the fire engine. Activation signals can be coded to turn on specific boots, or general to turn on all boots at a scene. The boots can use rechargeable batteries.

### BACKGROUND

1. Field of the Invention

The present invention relates generally to firefighting equipment and more particularly to a firefighter's emergency light that emits from the bottom of a firefighter boot.

2. Description of the Problem

Firefighters are called upon to enter burning structures wearing safety equipment including heat-resistant suits, breathing air tanks, gloves and boots. Unfortunately, due to smoke and other causes, it can be extremely dark inside such a structure. When entering such a structure, firefighters normally drop to their knees and crawl. This keeps them close to the floor where there is less smoke, more visibility, and it is cooler. While firefighters carry lights to light the way ahead of them, it is many times impossible for a particular firefighter to see the person ahead of him or her. Also, if a firefighter becomes lost, falls through, it may be difficult or impossible to find them.

What is badly needed is a blinking emergency light that can be automatically and remotely activated and emits a bright blinking beam from the heel (or sole) bottom of a firefighter's boot.

There are many blinking lights on shoes and other footwear in the prior art; however, most of these are decorative or used in sports for either safety or training. None emit from the bottom of the shoe or boot.

U.S. Pat. No. 4,158,922 issued to Dana shows a flashing disco shoe. Wong in U.S. Pat. No. 7,059,739 teaches ice skates with flashing lights. U.S. Pat. No. 6,789,913 issued to Wei shows a multifunction shoe flashing device. U.S. Pat. No. 5,473,518 issued to Haber et al. shows a removable flashing light housing for an athletic shoe.

None of these prior art lights activate automatically, and none of them face out of the bottom of the heel or sole In particular, none of the prior art footwear with lights, or lights adapted to footwear relate to firefighter's boots or are adapted for increasing the visibility of a person crawling.

It would extremely advantageous to have a very bright emergency light that emits from the bottom of a firefighter's boot.

### SUMMARY OF THE INVENTION

The present invention relates to a very bright LED (or other source) light that can be installed in the heel (or sole) of a firefighter's boot (or other boot or shoe). The boot can cast a very bright, blinking beam downward out of the bottom of the heel (or sole) to be seen by other firefighters crawling inside of structures. The LEDs should be white for maximum visibility in the darkness, and should blink at a rate of several times a second so they stand out from any other light source. Typical blink rates are between 1 Hz and 10 Hz. The LEDs should be electronically activated either from a radio unit located at a control point for example, on the fire engine. It is preferred that once-activated, the light cannot be turned off except by a radio signal from a control point such as the fire engine. The boot can also contain GPS or assisted GPS to allow a turn-on within a particular location. In this case, a GPS receiver can activate the light source. The boot can be equipped with a rechargeable battery of the type that can be charged either with a cable or by placing it in proximity to a wireless charger. Optionally, the boot can contain a heat sensor and/or water sensor that can also turn on the light source.

The electronics and light source in a preferred embodiment can be contained in a removable, typically cylindrical module that is placed inside the heel or sole of a boot. The bottom of the heel or sole where light is to exit can contain an installed window with a durable plastic lens. The entire bottom of the boot, or in particular, the window or lens can be coated with a hydrophobic surface material that prevents mud and other debris from sticking.

All firefighter's boots within a predetermined distance from a control point such as the fire engine can be turned on by a radio signal from the control point, or particular boots can be turned on using coded signals.

Finally, the boot light source can optionally be tied to turn on with the firefighter's air supply so that when air is turned on, the boot light source also turns on. Communication between the air supply and the boot can be wireless.

### DESCRIPTION OF THE FIGURES

Attention is now directed to several drawings that illustrate features of the present invention:

FIG. 1 shows a side view of a firefighter's boot with an embodiment of the present invention installed.

FIG. 2 shows the embodiment of FIG. 1 with the electronics capsule removed.

FIG. 3 shows the contents of the electronic capsule from FIG. 2

FIG. 4 shows a control point transmitting a radio signal that activates all boot lights within a predetermined range.

FIG. 5 shows a tablet or laptop computer and radio transmitter unit located at a control point.

FIG. 6 shows a bottom surface of a boot heel with a window allowing light to exit the bottom of the boot.

FIG. 7 shows a wirelessly rechargeable battery for use with the present invention.

FIG. 8 shows a bottom view of a fireman's boot including a heel embodiment of the present invention.

Several drawings and illustrations have been presented to aid in understanding the present invention. The scope of the present invention is not limited to what is shown in the figures.

### DETAILED DESCRIPTION OF THE PREFERRED EMBODIMENTS

The present invention relates to a safety light source for a firefighter's boot that includes a heel-bottom (or sole bottom) blinking LED or other very bright light source that is activated from a central control point. The present invention allows a crawling individual behind to know exactly where a crawling individual ahead is.

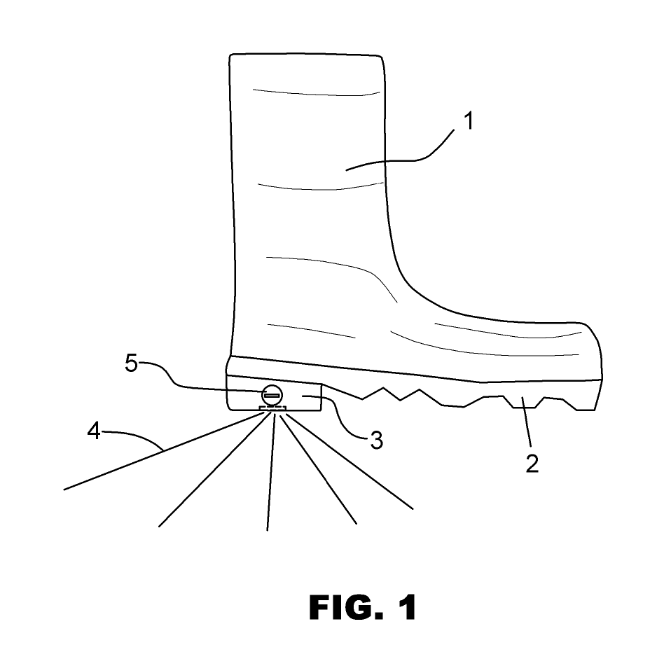

FIG. 1 shows a preferred embodiment of the present invention. A standard firefighter's boot 1 contains a downward-facing light source that can be contained in an insertable capsule that fits into a hollow portion of the boot 5 that projects light 4 away from the heel 3 in a wide arc. The downward-facing light source may also be optionally located in the sole 2. Using this arrangement, a standard or stock boot can be retrofitted to receive the present invention.

The light sources are typically activated by a wireless signal, normally a radio signal such as BLUETOOTH, WiFi or other short-range or local area radio technology. Any type of wireless signaling is within the scope of the present invention. Any of the embodiments of the present invention may also have their light sources optionally turned on manually by the firefighter. In the preferred embodiment, it is preferred that there is no way to turn off the light source, once on, except by a command via the wireless communications. This is so that no matter what the boot is subjected to, the light source will not turn off. Also, this prevents a firefighter from exiting a structure, turning off the light and then re-entering for some reason forgetting to re-activate the light.

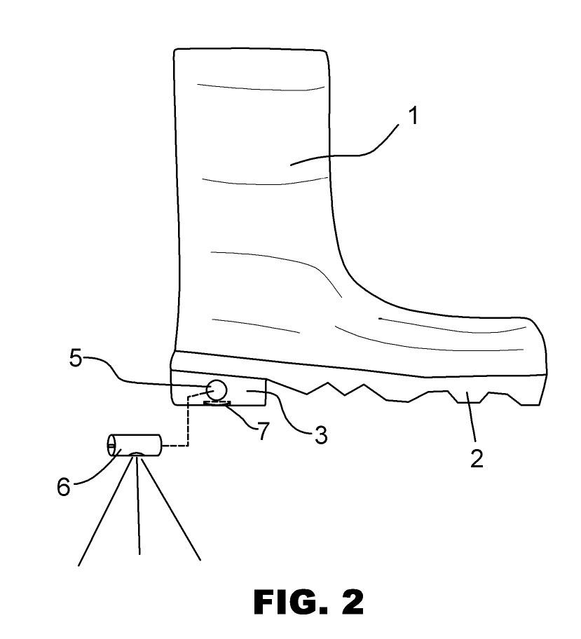

FIG. 2 shows the electronics and LED capsule 6 of the embodiment of FIG. 1 removed from the boot 1. FIG. 2 also shows a window 7 in the bottom of the heel. The window can contain a plastic lens. The lens can be made of very durable plastic of the type used in plastic windshields or any other very durable, transparent or translucent material. Because a boot may pick up mud, debris or other material that could cover the window 7 and block the light, the window 7 should be coated with a hydrophobic non-stick material known in the art. This eliminates that ability of mud and debris to stick to the window surface. It is also possible to coat the entire bottom of the boot, or the entire boot, with this material. A particular product is known as Ultra-Ever Dry™ manufactured and sold by Dry.Technology. This product is known in the art to totally prevent mud from adhering to boots.

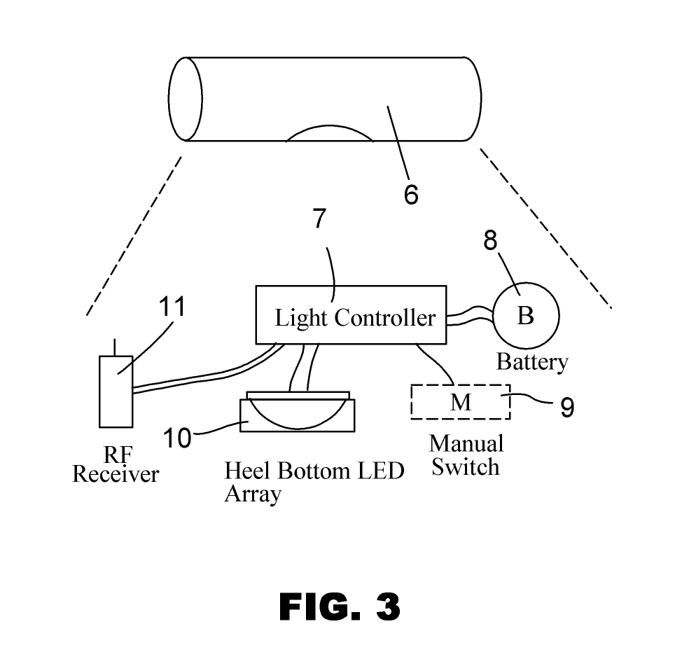

FIG. 3 shows the capsule 6, and its possible contents representing particular components placed inside the sole or heel of the boot of FIG. 1. The capsule 6 contains a battery 8 drives power to an LED control module 7 that is turned on by a radio receiver 11. The LED control module 7 drives a downward facing LED or LED array 10. The LEDs are typically bright white for maximum visibility in a dark, smoke-filled structure and typically blink at the rate of several times a second. While white is preferred, any color LED or any other light source is within the scope of the present invention. While blinking several times a second is preferred (1 Hz to 10 Hz), any blink rate including steady-on is within the scope of the present invention. While the preferred embodiment uses a removable capsule, the electronic components including the LEDs and LED driver circuits can be directly installed anywhere in the boot itself, strapped to the leg, or located anywhere on the firefighter.

The preferred battery 8 is a rechargeable battery of the type that can be recharged by bringing it into proximity with a wireless charging device. Optionally, any type of battery is within the scope of the present invention including a rechargeable battery with a cable and a replaceable battery or batteries. The radio receiver 11, can use any RF or other wireless technology. The preferred technology is BLUETOOTH; however, WiFi, special RF signaling, or any other method of remotely communicating with, or commanding, the module in the boot is within the scope of the present invention.

A typical blinker circuit uses a semi-conductor timer such as a 555 type integrated circuit known in the art or any other blinker circuit. It is very important that the blinker/timer circuit (as well as the RF receiver) be very rugged and be highly protected from shock since a fireman's boot will suffer tremendous shock and abuse. Typically, the electronic circuits can be mounted in a shock-resistant foam or other floating configuration inside the capsule 6 or directly in the sole or heel. The electronics and LED arrays must also be sealed against water penetration since a fireman's boot will many-times be subjected to water or other liquids. In fact, the bottom of the boot may sometimes be totally submerged in water.

The wireless receiver 9, typically an RF receiver, uses a short-range communications method such as BLUETOOTH or a local area communication technique such as WiFi. However, while these are preferred, a custom radio or other wireless method may be used. Any wireless communication method is within the scope of the present invention. The preferred wireless method is one-way radio (the boot module only receives).

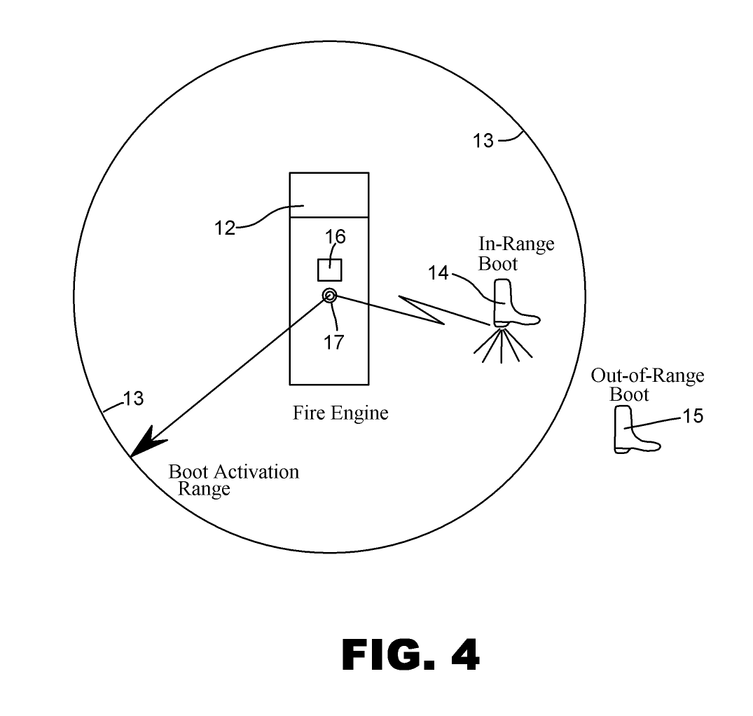

FIG. 4 shows an RF transmitter 16 at a control point such as the fire engine 12 with an omni-directional antenna 17. Signals from this transmitter cause the light source in the boot to activate. The power level of the transmitter 16 can be made adjustable to establish a boot-activation range 13. This range should typically be set to cover all fireman and equipment at a scene, or at least those from a particular fire engine. FIG. 4 shows a boot 14 that is in-range and activates from the fire engine signal, and a second boot 15 which is out-of-range and does not activate. The signal from the antenna 17 can be BLUETOOTH compatible to pair with the receivers in the boots as is known in the art; however, any RF or other wireless signal or technique is within the scope of the present invention.

It is possible to alternatively activate any boot that leaves the RF signal field from the fire engine (based on signal strength). This case works the opposite of the embodiment of FIG. 4. The field perimeter is set by adjusting signal strength of the radiated signal. As long as a particular boot receives a signal above a minimum threshold signal strength, the boot remains off. As the wearer walks outside the range of the signal, the boot circuitry senses a very low signal strength (or total loss of signal strength) and turns on. In this case, the boots need some sort of manual off-on switch so that they do not remain activated all the time.

Optionally, the boot can be caused to activate manually using a small manual switch mounted on the capsule or boot. This feature can be useful for testing the boots at the station. However, the preferred embodiment only uses the radio signal to turn the boot light on and off.

In an alternate embodiment, the capsule or circuitry in the boot can be connected to the air supply valve on the fireman's air supply unit using an air supply switch 12. This connection can be by wire, but since wire is cumbersome, the connection can also be by RF signal to the RF receiver 9.

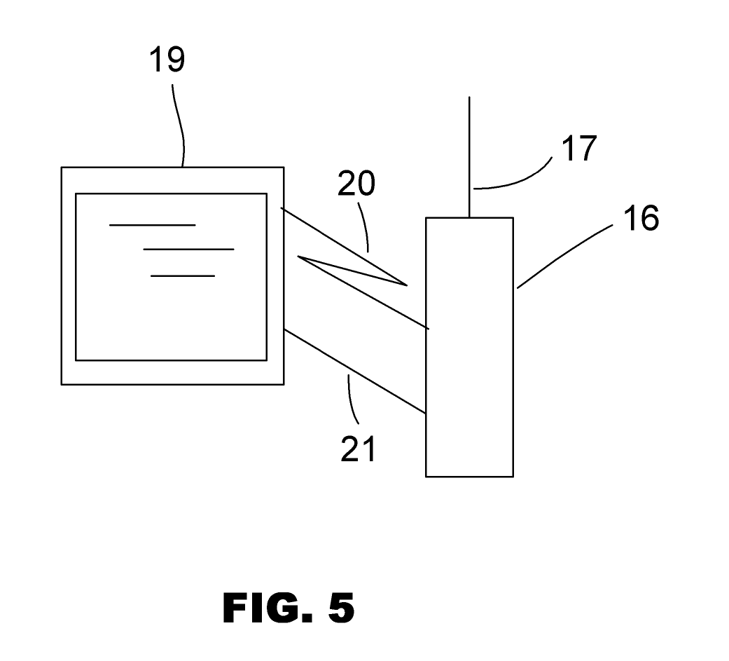

FIG. 5 shows a tablet or laptop computer 19 that can be located at the control point as well as an RF transmitter 16 with antenna 17. The tablet 19 can be hardwired 21 to the RF transmitter 16, or it can communicate with the RF transmitter 16 wirelessly 21. A typical wireless technique between the tablet computer 19 and the RF transmitter 16 can be short-range communications known as BLUETOOTH or similar.

In an alternate embodiment, the tablet or laptop computer 19 (or a control unit or computer built into the fire engine) can display a screen that allows a commander to select groups of boots to activate. This allows firefighters to be grouped into teams for structure entry. This way, even though every firefighter at the scene may be wearing similar boots with light sources, only one or more particular team that is going to enter the structure will have the boots activated. The RF transmitter 16 in this alternate embodiment then broadcasts a coded message to all boots at the scene; however, only those belonging to the particular assigned code group will activate. Boots can be supplied with permanent build-in boot activation codes or individual boots may have a way of setting up unique codes. Typically pairs of boots have the same boot activation codes so that both boots of a pair turn on at the same time.

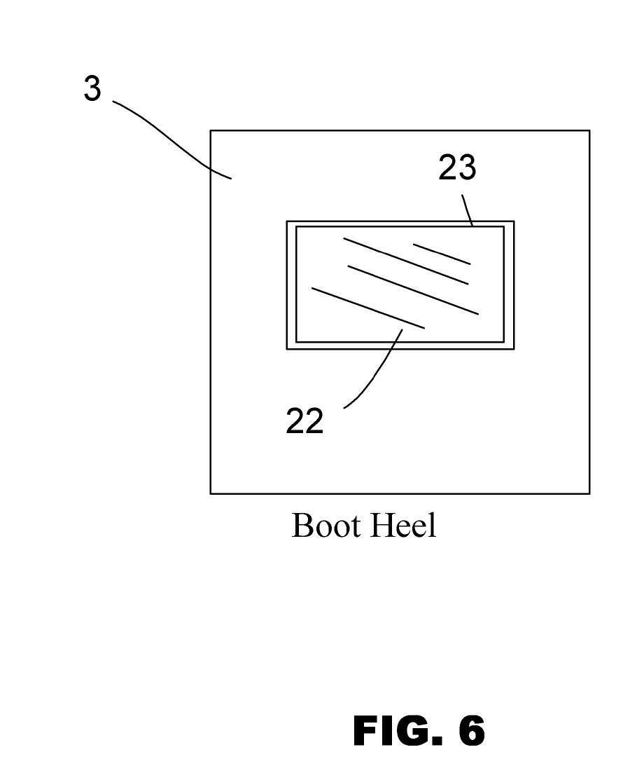

FIG. 6 shows a bottom view of a boot heel 3. The light window 22 can be very durable plastic of the type used to make plastic windshields. A hydrophobic coating 23 (previously discussed) can cover the window 22. This coating prevents mud and other debris from sticking to the window 22 and obscuring it.

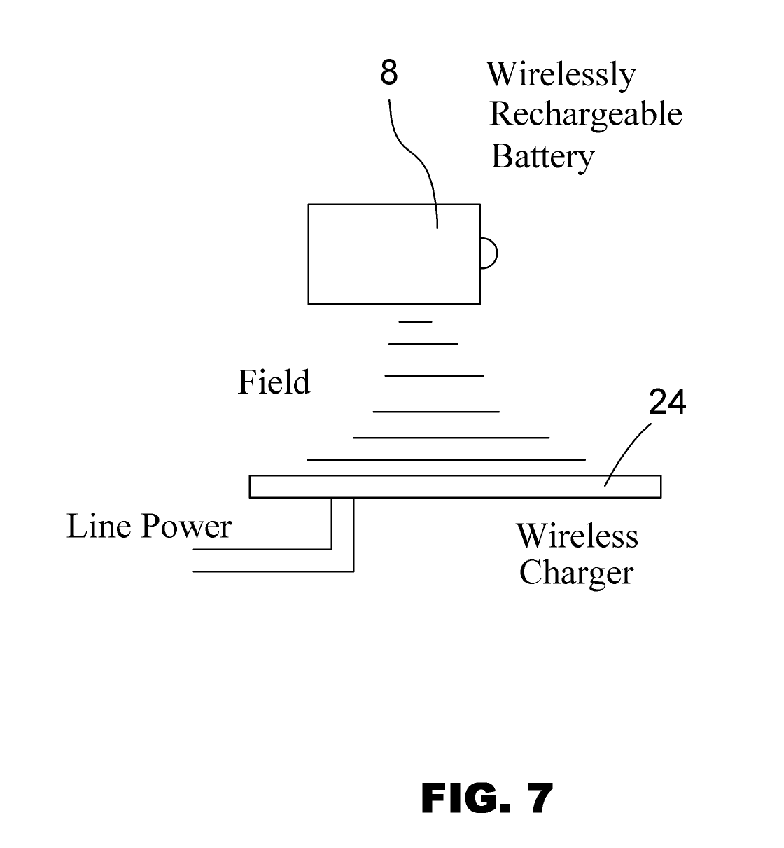

FIG. 7 shows a rechargeable battery 8 that can charge when brought into proximity with a wireless charger 24 known in the art. This type of charger typically uses low frequency, near-fields to transfer energy from the charger to the battery.

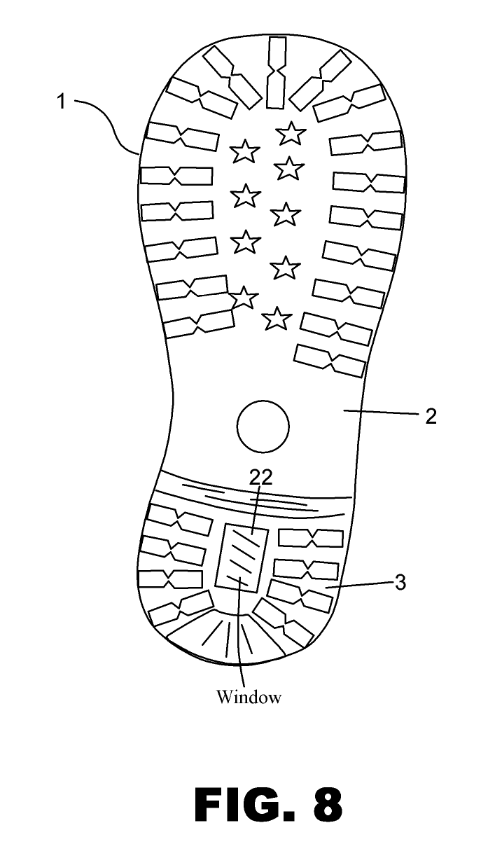

FIG. 8 shows the bottom of a fireman's boot 1 with a sole 2 and heel 3. A light window 22 is located in this embodiment in the heel. In an alternate embodiment, the window could be located in the sole 2.

The present invention is not restricted to use in fireman's boots, but in a more general context may be used with any shoe or boot. It is especially useful to hikers and rock climbers as a safety device.

Several descriptions and illustrations have been presented to aid in understanding the present invention. One with skill in the art will realize that numerous changes and variations may be made without departing from the spirit of the invention. Each of these changes and variations is within the scope of the present invention.

I claim:

1. A firefighter's emergency boot light comprising:
a light source adapted to be mounted in a boot heel or sole and configured to project light out from a bottom surface of the boot heel or sole, whereby, a crawling first firefighter's feet are visible to a second crawling firefighter behind the first firefighter.

2. The firefighter's emergency boot light of claim 1 further comprising a wireless module adapted to receive and activate the light source upon receiving a wireless turn-on signal.

3. The firefighter's emergency boot light of claim 2 wherein said wireless module is adapted to activate the light source upon receiving a general boot activation code transmitted from a control point.

4. The firefighter's emergency boot light of claim 2 wherein said wireless module is adapted to activate the light source upon receiving an individualized boot activation code unique to that boot.

5. The firefighter's boot of claim 1 further comprising one or more rechargeable batteries configured to supply current to said light source.

6. The firefighter's emergency boot light of claim 5 wherein the rechargeable battery is configured to recharge wirelessly.

7. The firefighter's emergency boot light of claim 1 wherein said light source blinks at a rate between 1 Hz and 10 Hz.

8. The firefighter's emergency boot light of claim 1 wherein said light source is contained in a removable capsule.

9. The firefighter's emergency boot light of claim 1 wherein said light source includes a battery, light controller, an LED or LED array, and an RF receiver, the battery configured to supply power to the light controller; the light controller configured to supply current to the LED or LED array, and the RF receiver configured to command the light controller to turn on the LED or LED array upon receipt of a predetermined RF signal.

10. The firefighters emergency boot light of claim 1 further comprising a transparent or translucent window in the bottom of the heel or sole.

11. The firefighter's emergency boot light of claim 10 wherein said window is coated with a hydrophobic layer.

12. A firefighter's emergency boot light comprising:
a blinking downward-facing light source configured to be mounted in the bottom surface of a sole or heel of a fireman's boot;
a wireless module adapted to receive a predetermined wireless command that activates the light source.

13. The firefighter's emergency boot light of claim 12 wherein said wireless module causes the light source to activate upon receiving a coded command unique to a particular boot.

14. The firefighter's boot of claim 12 further comprising one or more rechargeable batteries configured to supply current to said light source.

15. The firefighter's emergency boot light of claim 14 wherein said rechargeable battery is of the type that can be recharged wirelessly.

16. The firefighter's boot of claim 12 wherein said light source blinks at a rate between 1 Hz and 10 Hz.

17. A method of enhancing firefighter safety comprising:
supplying a blinking downward-facing light source configured to be mounted in the bottom surface of a sole or heel of a fireman's boot;
supplying a wireless module adapted to receive a predetermined wireless command that activates the light source.

18. The method of claim 17 further comprising supplying a window adapted to be mounted in the bottom of a heel or sole of a fireman's boot, the window configured to transmit light from the light source out of the bottom of the heel or sole.

19. The method of claim 18 wherein the window is coated with a hydrophobic, no-stick layer.

20. The method of claim 18 wherein said light source and said wireless module are contained in a capsule adapted to be inserted into a boot heel or sole.
